(19) United States
(12) Patent Application Publication
(10) Pub. No.: US 2013/0187464 A1
(43) Pub. Date: Jul. 25, 2013

(54) System and Method for Portable Solar Array Deployment

(71) Applicant: Seldon Energy Partners, LLC, Dallas, TX (US)

(72) Inventors: Mark Berry Smith, Dallas, TX (US); David Charles Bisig, JR., Dripping Springs, TX (US); William Tol Harris, Georgetown, TX (US)

(73) Assignee: SELDON ENERGY PARTNERS, LLC, Dallas, TX (US)

(21) Appl. No.: 13/747,149

(22) Filed: Jan. 22, 2013

Related U.S. Application Data
(60) Provisional application No. 61/589,708, filed on Jan. 23, 2012.
(60) Provisional application No. 61/589,705, filed on Jan. 23, 2012.

(51) Int. Cl. H02J 3/38; H02J 7/00

(52) U.S. Cl. CPC H02J 3/38; H02J 7/0052
USPC 307/47; 320/101; 307/68

(57) ABSTRACT

A deployable portable solar system is provided. The portable solar system provides power for industrial use situations. The portable solar system contains solar cells, one or more charge controllers, one or more battery banks, DC to AC inverters, and a disconnect. Optionally, the solar system contains a backup AC generator, one or more transfer switches, a backup DC generator, a utility line connection, one or more transformers, and a variable frequency drive.

### CROSS-REFERENCE TO RELATED APPLICATIONS

The present application claims priority to U.S. Provisional Patent Application No. 61/589,708, filed on Jan. 23, 2012 by Mark Berry Smith, et al., entitled “System and Method for Portable Solar Array Deployment,” and U.S. Provisional Patent Application No. 61/589,705, filed on Jan. 23, 2012 by Mark Berry Smith, et al., entitled “Solar Power System,” which are both incorporated by reference herein as if reproduced in their entireties.

### BACKGROUND

Some sources of electrical energy provide electrical power at undesirably high cost, with inconvenient power quality characteristics, and/or are not environmentally friendly. Some applications that consume electrical power are located relatively remote from conveniently available commercial electrical grid systems. Some applications that consume electrical power are temporary in nature and may not be suitable for connection to commercial electrical grid systems to receive electrical energy from the commercial grid systems or to provide electrical energy to the commercial grid systems. Some solar power systems are configured as permanent installations and/or are not readily deployable and/or may not be suitable for convenient use at successively different geographic locations. Some solar power systems are not configured for industrial applications such as for providing greater than about 1 kW capacity, two phase or three phase alternating current, and/or voltages greater than about 110 VAC.

### BRIEF DESCRIPTION OF THE DRAWINGS

For a more complete understanding of this disclosure, reference is now made to the following brief description, taken in connection with the accompanying drawings and detailed description, wherein like reference numerals represent substantially similar parts.

FIG. 1 is a diagram of a solar power system.

FIG. 2 is a diagram of an electrical configuration of a deployable solar power system.

FIG. 3 illustrates a processor and related components suitable for controlling the deployable solar power system.

FIG. 4 is a diagram of an alternate electrical configuration of a deployable solar power system.

### DETAILED DESCRIPTION

This disclosure provides, in some embodiments, systems and methods for providing portable, rapidly deployable, and rapidly removable solar power energy while imparting a minimal amount of environmental damage as a result of the deployment of the solar power system. In some embodiments, the solar power systems disclosed herein may be configured to provide direct current from about 0.01 Volts to about 1500 Volts and/or alternating current ranging from less than about 0.01 Volts to about 1200 Volts and above. In some embodiments, the solar power systems disclosed herein may be configured to provide single-phase, two-phase, and/or three-phase power. In some embodiments, the solar power systems disclosed herein may generally utilize one or more photovoltaic cells configured to provide electrical current to one or more batteries or charge controllers for batteries. In some embodiments, the batteries may feed power inverters, rectifiers, transformers, and/or other electrical components to supply a selected type of electrical power from the options described above. Further and more detailed disclosure and discussion of the electrical systems of the solar power systems disclosed herein may be found in the U.S. Provisional patent application of the same Applicants of this disclosure and which was filed on Jan. 23, 2012 and entitled “SOLAR POWER SYSTEM” and which is hereby incorporated by reference in its entirety. It will be appreciated that while some systems and components common to this disclosure and the provisional patent application incorporated by reference may be illustrated, described, labeled, and/or configured differently, the combination of disclosures is not inconsistent in substance and variations should be interpreted as alternative embodiments comprising combinations of the varied descriptions.

In certain geographic locations, utility power may not be readily available or may be relatively expensive to acquire. For example, once a new well has been drilled it may need to be operated but the electrical grid power may not be available for four-to-six months or more. Also there may be a need for temporary power, such as in the aftermath of natural disasters. In these locations, a portable electrical generator may be desirable. Some generators may be powered by fossil fuels or other non-renewable energy sources, resulting in higher operating costs and pollution. Some generators may be powered by solar cells or other renewable energy sources, but may not provide sufficient power to support industrial applications. Presented herein is a system and method for a portable solar array capable of providing power sufficient to meet the demands of industrial applications. For example, a portable solar array may be configured to provide 480 volt (V) 3-phase alternating current (AC) voltage up to 20 to 30 or more kilowatts (kW) for use in industrial applications.

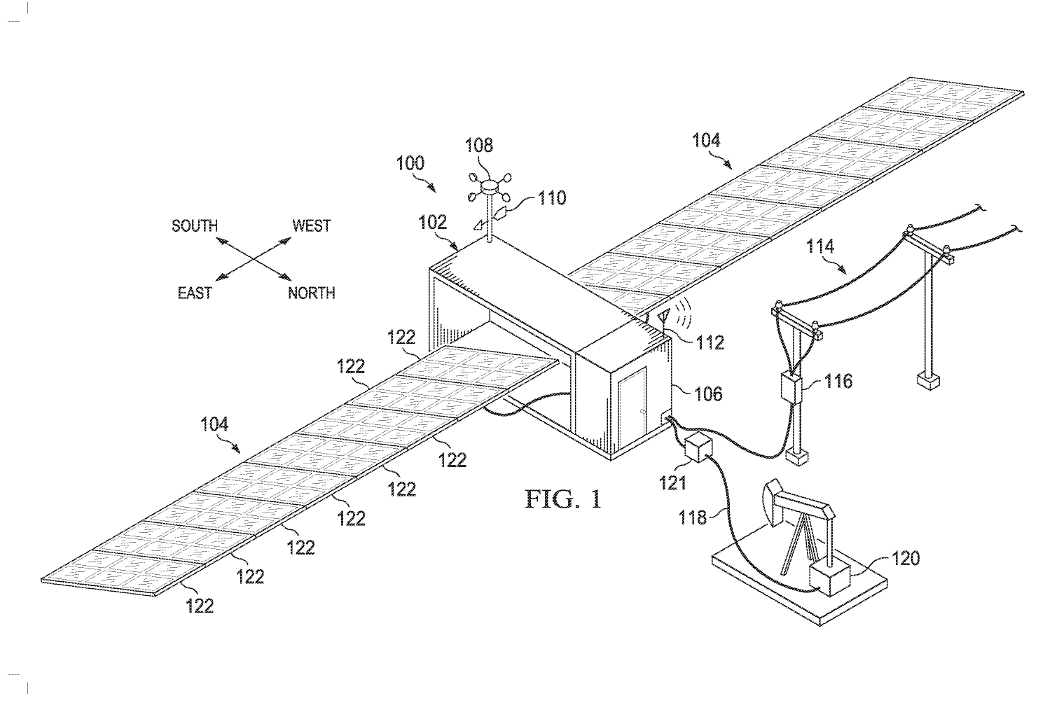

Referring now to FIG. 1 in the drawings, a solar power system 100 is shown as deployed to an oil-producing well site. Generally, the solar power system 100 comprises a transportable container 102, a plurality of solar arms 104, and an electrical control room 106. The container 102 may comprise a cargo box or shipping type container or other skid or trailer mounted box-like enclosure or pad. The container may be sized and shaped so that transportation of the container 102 is convenient and/or allowed by rail, tractor-trailer over public roadways, shipping at sea, and/or may be configured to be carried by helicopter and/or other aircraft. Regardless the mode of transport, the container 102 may be configured to serve as a delivery package for the solar power system 100 by selectively housing the components of the solar arms 104, the control room 106, and any other components necessary to generate solar power while the solar power system 100 is in a transport configuration.

The solar power system 100 is shown as further comprising an anemometer 108 for measuring, monitoring, and/or reporting wind speed and a weather vane 110 for measuring, monitoring, and/or reporting wind direction. The solar power system 100 is shown as further comprising a remote and/or wireless communication device 112 for measuring, monitoring, and/or reporting the status of the status of the solar power system 100 and/or the environment in which the solar power system 100 is disposed. The wireless communication device 112 may further receive instructions for controlling any of the electrical systems of the solar power system 100 and/or for controlling any automated, mechanized, and/or selectively actuated aspects of the solar power system 100. The solar power system 100 may comprise electrical components external to the control room 106 and such components may be mounted relatively closer to a source of commercial electrical power 114 in a remote enclosure 116. In some embodiments, a circuit breaker or electrical disconnect device may be associated with the remote disclosure to selectively connect and disconnect the solar power system 100 to the commercial electrical grid 114. In some embodiments, the solar power system 100 may comprise a circuit breaker or electrical disconnect device 121 to selectively connect and disconnect the load 120 from the solar power system 100. Additionally, the solar power system 100 may comprise a load line 118 that supplies electrical energy to a load 120. In the embodiment shown, the load 120 may comprise an electrical motor configured to cause mechanical reciprocation of a component of an oil pump.

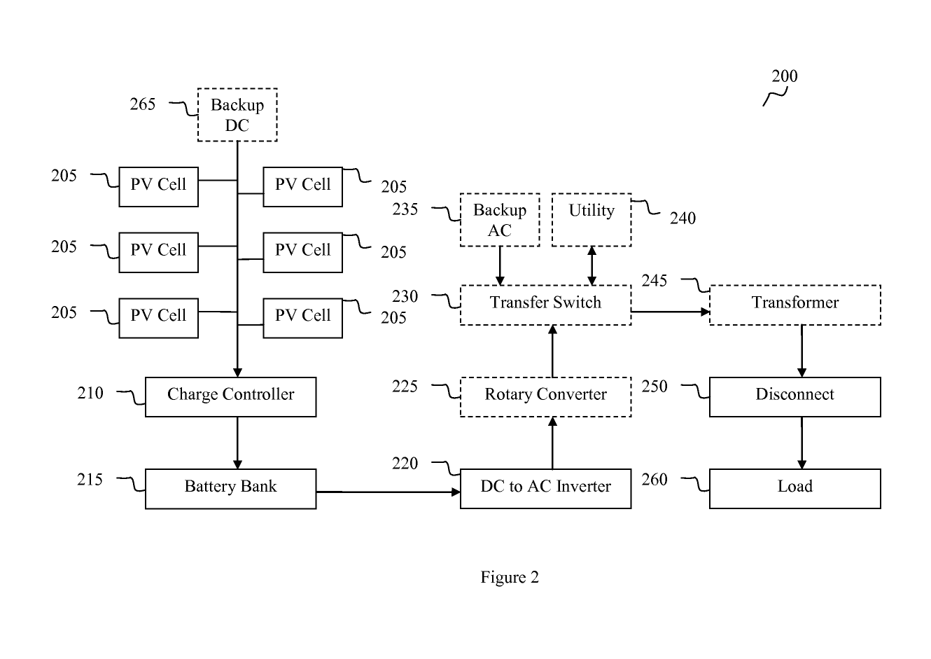

FIG. 2 is a diagram of an electrical configuration 200 of a deployable solar power system. All or part of the electrical configuration 200 may be contained within the control room 106. Certain components of the electrical configuration 200 may be external to the control room 106. In addition, the electrical configuration 200 may be modular in nature, thus certain modules may be installed separately from the control room 106 upon deployment of the solar power system 100.

The electrical configuration may comprise one or more solar cells 205. The cells may be photovoltaic (PV) cells, or any other cell capable of producing en electric current utilizing energy from the sun. While six solar cells 205 are depicted, any number may be used depending upon the requirements of the load 260. In certain embodiments, the number of solar cells 205 may be divisible by two or three. The solar cells 205 may be electrically connected to one or more charge controllers 210. While only one charge controller 210 is depicted, several may be used depending upon the number of solar cells 205 and/or electrical devices used. Optionally, a backup direct current (DC) generator 265 may be electrically connected to the charge controller 210. The charge controller 210 may be electrically connected to a battery bank 215.

The battery bank 215 may be electrically connected to a DC to AC inverter 220. The output of the DC to AC inverter 220 may be optionally electrically connected to a rotary converter 225, or a transfer switch 230. Additionally, an optional backup AC generator may be electrically connected to the transfer switch 230 in some embodiments, however the transfer switch may be absent in other embodiments. Another optional connection may include electrically connecting utility power 240 to the transfer switch 230.

The output of the transfer switch 230 may be electrically connected to a transformer 245. The output of the transformer 245 may be electrically connected to a disconnect 250, and the output of the disconnect may be electrically connected to a load 260.

In an embodiment, the solar cells 205 may be configured in an array comprising several solar cells. The solar power system 100 may comprise several arrays. Based upon the type of charge controller 210 selected for use, several charge controllers 210 may be required for charging one or more battery banks 215.

One or more battery banks 215 may comprise many batteries electrically connected in series and/or parallel depending upon the voltage and current requirements of the load 260. The batteries may be selected to provide up to 24 hours or more of power to the load 260. One or more battery banks 215 may also be used in the case when solar power may not be readily available due to natural or unnatural conditions. The battery bank 215 may also support a surge power draw required by the load 260. For example, in certain applications, when a motor starts, the initial draw of current may be two, three, six, ten or more times the normal operating draw of the motor. One or more battery banks 215 may be configured to accommodate the surge draw of the load 260. In addition, the battery banks 215 may provide cleaner power than a typical fossil fuel generator. Cleaner power may comprise fewer current spikes, drop-outs, troughs, noise, or other problems associated with “dirty” power. When a typical fossil fuel generator starts, there may be a power spike or trough. The solar cells 205 and the battery bank 215 reduce the possibility of a power spike or trough during operation of the solar power system 100. One or more battery banks 215 may be stored within the control room 106 and/or externally, based upon the size of the battery banks 215, or other needs. In certain embodiments, a battery bank 215 may not be needed, or may be relatively small. For example, if the load 260 is only running when sunlight is available to the solar cells 205, then little or no battery bank 215 may be needed.

The battery bank 215 provides a DC voltage and current to one or more DC to AC inverters 220. The DC to AC inverter 220 may be a single phase 120 VAC or 240 VAC inverter, or a two or three phase 208 VAC inverter, or any other DC to AC inverter as needed. While only one DC to AC inverter 220 is depicted, several DC to AC inverters 220 may be used as needed based upon the type of load 260 or other uses of the solar power system 100. If the DC to AC inverter 220 is a single phase inverter, a rotary converter 225 may be electrically connected to the output of the DC to AC inverter 220. The rotary converter 225 may convert the single phase output of DC to AC inverter 220 to 3 phase power. The output of the DC to AC inverter 220 or the output of the rotary converter 225 may be connected to the transfer switch 230.

Optionally, in certain embodiments, a backup AC generator 235 may be electrically connected to the transfer switch 230. The backup AC generator 235 may be used if the battery bank 215 malfunctions or is unable to provide sufficient power to the load 260. In certain embodiments a connection to utility power 240 may be available. The utility power 240 may be used if the battery bank 215 malfunctions or is unable to provide sufficient power to the load 260. In certain other embodiments, both the backup AC generator 235 and utility power 240 may be available. The connection to utility power 240 may also be used to supply excess power generated by the solar power system 100 to the utility power 240 grid. This excess power may be sold to or used by an energy provider or other power user connected to the utility power 240 grid.

In some embodiments, the transfer switch 230 may provide 208 VAC legs of power to transformer 245, while in other embodiments the transfer switch 230 may provide 480 VAC three phase power. The output voltage of the transfer switch 230 may vary based upon the output of the DC to AC inverter 220, rotary converter 225, alternate or backup AC generator 235, and utility power 240. In some embodiments, if there is no backup AC 235 or utility power 240 connected to the solar power system 100, then a transfer switch may 230 may not be needed. Transformer 245 may step-up or step-down the input voltage from the transfer switch 230 to three phase 480 VAC, or other voltages, for use by the load 260. The output of the transformer 245 may vary depending upon the needs of the load 260. For example, the transformer may output single phase, two phase, or three phase power at any voltage depending upon the needs of the load 260 and/or configuration of the electrical configuration 200. In some embodiments, the transformer 245 may not be included with the solar power system 100. For example, if the load 260 requires power matching the output characteristics of the DC to AC inverter 220, then a transformer 245 may not be necessary.

The disconnect 250 may provide an interface between the load 260 and the transformer 245. The disconnect 250 may be used for safety purposes, providing an emergency shutoff for the load.

In another embodiment, there may be 96 solar cells in the solar power system 100. Each solar cell may produce 250 watts (W) of power. The output voltage of the solar cells may be 48 VDC. Each charge controller may be capable of handling 150 amps (A) at 48 VDC. Thus, 6 charge controllers may be used. The battery bank may be capable of supporting a current draw of 96 A at 48 VDC. The DC to AC inverter may receive the 48 VDC from the battery bank and generate either single phase 240 VAC or three phase 208 VAC. If the DC to AC inverter generates single phase power, a rotary converter may optionally be used to generate 3 phase power. In any case, 208 VAC three phase power may be provided to the optional transfer switch from any of the DC to AC inverter, the rotary converter, the utility line in, or the AC backup generator. The transfer switch may switch to the appropriate power source and provide an output to the transformer. The transformer may convert the 208 VAC legs of power to 480 VAC three phase power for an industrial load. Alternatively, the transformer may, if needed, provide 240 VAC single phase power, or 120 VAC single phase power. If higher voltages and/or amperages are required, several solar power systems may be electrically connected together to provide the higher power.

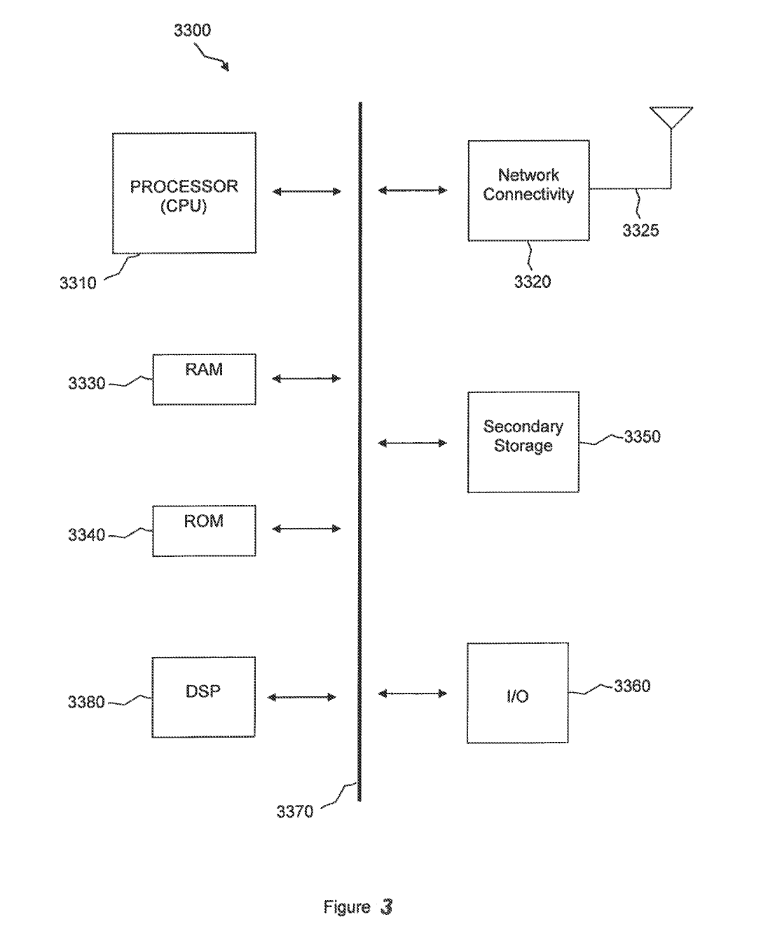

The components described above might include a processing component that is capable of executing instructions related to the actions described above, for example, automating or monitoring the systems. FIG. 3 illustrates an example of a system 3300 that includes a processing component 3310 suitable for use in one or more embodiments disclosed herein. In addition to the processor 3310 (which may be referred to as a central processor unit or CPU), the system 3300 might include network connectivity devices 3320, random access memory (RAM) 3330, read only memory (ROM) 3340, secondary storage 3350, and input/output (I/O) devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a digital signal processor (DSP) 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 3320 may enable the processor 3310 to communicate with the Internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 3325 might be considered to be a component of the I/O devices 3360 instead of or in addition to being a component of the network connectivity devices 3320.

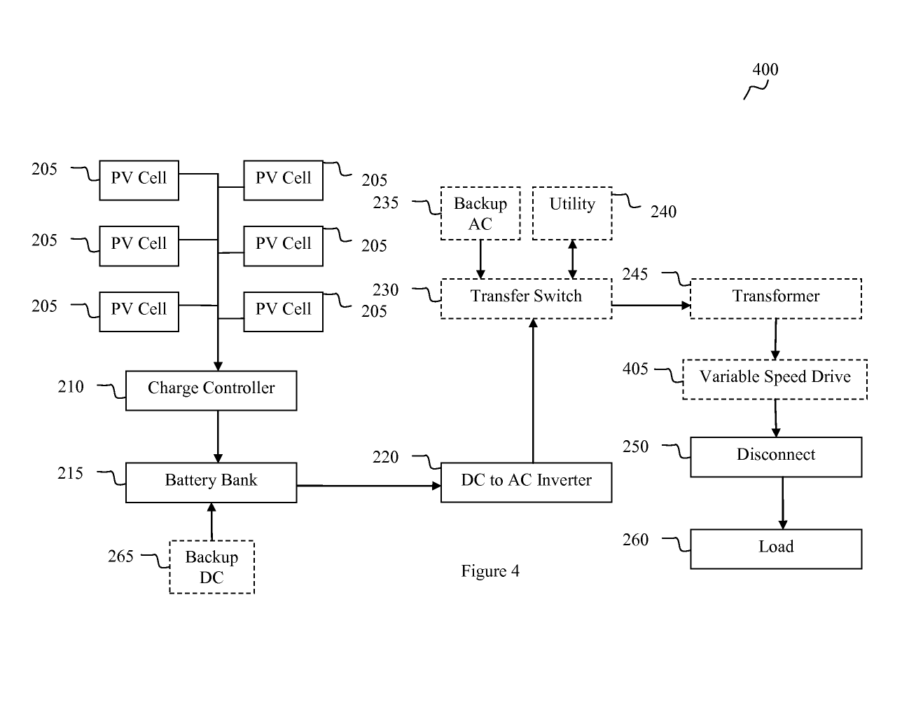

FIG. 4 is a diagram of an alternate electrical configuration 400 of a deployable solar power system. The alternate electrical configuration 400 may be configured similarly and function similarly to electrical configuration 200. Alternate electrical configuration 400 may not contain a rotary converter 225. In addition in alternate electrical configuration 400, the backup DC generator 265 maybe connected directly to the battery bank 215. The backup DC generator 265 may be used when the PV cells 205 fail to provide enough power to the load 260. The backup DC generator 265 may comprise a charge controller not pictured.

The alternate electrical configuration 400 may optionally comprise a variable frequency drive 405. The variable frequency drive 405 may receive the output of transformer 245, transfer switch 230, or DC to AC inverter 220 depending on the selected configuration of optional components. The variable frequency drive may output to the disconnect 250. The variable frequency drive 405 may be selected to compensate for a significant amount of in-rush current resulting from starting the load 260 from an off state. The variable frequency drive 405 may also be selected for loads 260 that experience a change in electrical resistance while running. Loads 260 with constant resistance and little-to-no in-rush current may not require a variable frequency drive 405 as the loads 260 will draw a constant amount of current from the alternate electrical configuration 400. A combination of the electrical configuration 200 and the alternate electrical configuration 400 may be used in certain embodiments depending upon the needs of the load 260. For example, a portable solar array may be configured to output 480 volt (V), 3-phase alternating current (AC), providing up to and potentially more than 20 to 30 or more kilowatts (kW) of power for use in industrial applications.

The present disclosure provides illustrative implementations of one or more embodiments. The disclosure should in no way be limited to the illustrative implementations, drawings, and techniques illustrated below, including the exemplary designs and implementations illustrated and described herein, but may be modified within the scope of the appended claims along with their full scope of equivalents. A person of skill in the relevant art will recognized that the disclosed systems and/or methods may be implemented using any number of techniques, whether currently known or in existence.

This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A portable solar power generator comprising:
one or more solar cells;
one or more charge controllers electrically coupled to the one or more solar cells, the one or more charge controllers configured to receive power from the one or more solar cells;
a battery bank electrically coupled to the one or more charge controllers, the one or more charge controllers configured to charge the battery bank;
one or more direct current (DC) to alternating current (AC) inverters electrically coupled to the battery bank; and
a disconnect electrically coupled to the one or more DC to AC inverters, the one or more DC to AC inverters configured to provide AC current via the disconnect.

2. The portable solar power generator of claim 1, further comprising a backup DC generator.

3. The portable solar power generator of claim 1, further comprising a rotary converter electrically coupled to the one or more DC to AC inverters.

4. The portable solar power generator of claim 1, wherein the generator is configured to provide single, dual, or three phase power.

5. The portable solar power generator of claim 1, further comprising a transfer switch electrically coupled to one or more of a group consisting of a backup AC generator, a combustion generator, and a utility power line.

6. The portable solar power generator of claim 5, wherein an electrical component is configured to provide excess power generated by the one or more solar cells to the utility power line.

7. The portable solar power generator of claim 6, wherein the excess power is power that is generated in excess of the power requirements of a load electrically coupled to the disconnect.

8. The portable solar power generator of claim 5, wherein the backup AC generator is configured to activate when the battery bank malfunctions.

9. The portable solar power generator of claim 5, wherein the backup AC generator is configured to activate when the battery bank is unable to provide sufficient operating power to a load electrically coupled to the disconnect.

10. The portable solar power generator of claim 1, further comprising a transformer electrically coupled to the DC to AC inverter.

11. The portable solar power generator of claim 10, wherein the transformer is configured to receive legs of 208 VAC power and output three phase 480 VAC power.

12. The portable solar power generator of claim 10, wherein an output of the transformer varies based on one or more of: an output of the DC to AC inverters, an output of a rotary converter, an output of a backup generator, or an output of utility power, and wherein the output of the transformer is selected to provide sufficient operating power to a load electrically coupled to the disconnect.

13. The portable solar power generator of claim 1, wherein the battery bank is configured to support an inrush current of power related to start-up of a load electrically coupled to the disconnect.

14. The portable solar power generator of claim 1, wherein the battery bank comprises a plurality of batteries, wherein a number of the plurality of batteries is selected based upon the power requirements of a load electrically coupled to the disconnect.

15. The portable solar power generator of claim 1, wherein the battery bank comprises a plurality of batteries, wherein a number of the plurality of batteries is selected based upon one or more of:
providing continuous power for twenty-four hours to a load electrically coupled to the disconnect; and
the operating hours of the load.

16. The portable solar power generator of claim 1, further comprising a transformer, wherein the plurality of solar cells comprises 96 solar cells, wherein each of the solar cells is configured to output 230 watts (W) of power at 48 volts (V) DC, wherein the one or more charge controllers comprises 6 charge controllers, wherein each of the 6 charge controllers is configured to provide 150 amps (A) at 48 VDC, wherein the battery bank is configured to provide a surge current of 96 A at 48 VDC, wherein the DC to AC inverter receives 48 VDC from the battery bank and outputs three phase 208 VAC, and wherein the transformer receives the three phase 208 VAC and outputs three phase 480 VAC.

17. The portable solar power generator of claim 1 further comprising:
a transformer; and
wherein the plurality of solar cells comprises 96 solar cells, wherein each of the solar cells is configured to output 250 watts (W) of power at 48 volts (V) DC, wherein the one or more charge controllers comprises 6 charge controllers, wherein each of the 6 charge controllers is configured to provide 150 amps (A) at 48 VDC, wherein the battery bank is configured to provide a surge current of 96 A at 48 VDC, wherein the DC to AC inverter receives 48 VDC from the battery bank and outputs three phase 208 VAC, and wherein the transformer receives the three phase 208 VAC and outputs three phase 480 VAC.

18. The portable solar power generator of claim 1 further comprising:
a variable frequency drive, wherein the variable frequency drive is selected based upon one or more of:
an in-rush current resulting from starting of a load electrically coupled to the disconnect; and
a change in electrical resistance of the load while running.

19. A method for providing industrial solar power comprising:
generating an output voltage from an array of solar cells;
receiving the output voltage at a charge controller;
charging a battery bank by the charge controller using the output voltage;
receiving a DC battery voltage from the battery bank at a DC to AC inverter;
converting the DC battery voltage to an AC voltage by the DC to AC inverter; and
outputting the AC voltage by DC to AC inverter.

20. The method of claim 19, wherein the AC voltage is any one of single, dual and three phase power at any one of 110-120 VAC, 208-240 VAC, 460-480 VAC, and up to 800 VAC.

21. The method of claim 19, further comprising concurrently drawing power from a utility line as a secondary power source.

22. The method of claim 21, further comprising drawing power from the utility line when additional power is needed and supplying power to the utility line when the generated power exceeds the power required by an attached load.

23. The method of claim 21, wherein the utility line is supplying two phase or single phase power.

24. The method of claim 19, wherein one or more attached loads receive power directly from a variable frequency drive as well as power that bypasses the variable frequency drive.

25. The method of claim 19, further comprising a rotary converter receiving a single phase or two phase signal from the DC to AC inverter and wherein the rotary converter converts the power to three phase power.
